(19) United States
(12) Patent Application Publication
(10) Pub. No.: US 2018/0240147 A1
(43) Pub. Date: Aug. 23, 2018

(54) PROCESS AND SYSTEM FOR DETERMINING MARKETING ACTIVITY FREQUENCY WHILE MAINTAINING THE INFLUENCER'S IMPACT ON THEIR SOCIAL NETWORK

(71) Applicant: APIFIA, INC., Boston, MA (US)

(72) Inventors: Lyle Robert Stevens, Newton, MA (US); Sean Naegeli, Boston, MA (US); Howard L. Greene, Lincoln, NH (US); Brian Lindauer, Dover, MA (US)

(21) Appl. No.: 15/901,573

(22) Filed: Feb. 21, 2018

Related U.S. Application Data
(60) Provisional application No. 62/462,102, filed on Feb. 22, 2017.

(51) Int. Cl. G06Q 30/02; G06Q 50/00

(52) U.S. Cl. CPC G06Q 30/0244; G06Q 50/01; G06Q 30/0269; G06Q 30/0277; G06Q 30/0214; G06Q 30/0276

(57) ABSTRACT

A process suitable for managing activation of market influencers while minimizing degradation of influencer impact is provided. In particular, the present invention relates to a process that determines an optimal amount of marketing activities to maximize effectiveness while avoiding damaging or degradation of influencer impact quantities providing the marketing activities. Specifically, the present invention provides a system and process for optimizing an amount of content presented to potential customers by incentivized influential entities or users. The optimization of the content is structured to “activate” the influential entities or users to provide as much content as possible to achieve the biggest impact from the user's social network before diminishing returns begin to take effect on the impact of the influential entities or users.

### CROSS-REFERENCE TO RELATED APPLICATION(S)

This application claims priority to, and the benefit of, co-pending U.S. Provisional Application No. 62/462,102, filed Feb. 22, 2017, for all subject matter common to both applications. The disclosure of said provisional application is hereby incorporated by reference in its entirety.

### FIELD OF THE INVENTION

The present invention relates to process suitable for maximizing the return on investment for marketing initiatives. In particular, the present invention relates to a process that determines an optimal amount of marketing activities to implement and maximize effectiveness of the marketing activities while avoiding damaging or degradation of the influential entity (e.g., people, businesses, etc.) impact quantities.

### BACKGROUND

Generally, there are a number of different methodologies utilized to market products and/or services to potential customers. A common marketing technique is providing different forms of advertising over various multimedia mediums. Those mediums can include printed advertisements (e.g., magazines, billboards, newspapers, etc.), digital media advertising (e.g., radio, television, etc.), and with the advancement of technology and widespread use of the Internet, online advertising (e.g., webpages, mobile applications, etc.). Online advertising in particular includes additional marketing methodologies, such as targeting advertising based on big data, utilizing social media, incentivizing influential people/entities on social media to advertise products/services, and other well-known methods.

However, these methodologies experience some shortcomings. Specifically, a problem with advertising generally, especially including influencer-based advertising in online social media platforms, is that there is a diminishing return based on the amount of content provided to potential consumers. In particular, increases in advertising frequency provided to individuals (which is particularly easy to do to an unreasonable degree in a virtual online social network) can result in diminishing levels of effectiveness for those advertisements on the individuals. Conventional marketing campaigns are not optimized to prevent such degradation of effectiveness on individuals. Traditionally, marketing campaigns have been known to spam potential customers with advertisements, promotions, etc. to the point that the potential customers begin to ignore and/or become annoyed with the marketing efforts, which is one form of diminishment of effectiveness. Similarly, when the marketing leverages influencer entities (e.g., people, businesses, etc.) that potential customers follow and/or are connected to on social media, excessive marketing content provided via the influencers can become an annoyance to potential customer and can harm the influencer. Specifically, such activity can cause the potential customers to lash back at the influencer, stop following the influencer, or disconnect the influencer from their virtual social network, thus reducing the influence level and trust of the influencer, and therefore the associated value in having the influencer to market content (e.g., the effectiveness of the influencer).

### SUMMARY

There is a need for a process that recognizes and determines the diminishing returns associated with frequency of presenting marketing content to potential customers, so that marketing initiatives can be controlled to leverage but not substantially damage or degrade influencer impact qualities. The present invention is directed toward further solutions to address this need, in addition to having other desirable characteristics. Specifically, the present invention provides a system and method for optimizing an amount of content presented to potential customers, in particular, the amount of content presented to potential customers by incentivized influential entities or users (e.g., influencers). The present invention provides optimizations for “activating” the influential entities or users to provide as much content as possible to achieve the biggest impact from the influential entity's or user's social network before diminishing returns begin to take effect on the influential entity's or user's potential to drive marketing conversions.

In accordance with example embodiments of the present invention, a computer implemented process is provided. The process includes aggregating a plurality of influencers from a storage system of an online social network and a processor identifying at least one influencer from the plurality of influencers to be activated for new content creation. The identifying includes determining an influencer rating associated with each of the plurality of influencers, determining at least one social network post type for the new content creation to be posted, determining a time of a most recent social network content posting for each of the plurality of influencers, and determining a preferred at least one influencer from the plurality of influencers available to be activated based on the influencer rating, the at least one social network post type, and the time of a most recent content posting for each of the plurality of influencers. The process further includes outputting the preferred at least one influencer of the plurality of influences to be activated for the new content creation. The process minimizes a negative effect on a level of impact the preferred at least one influencer has over potential customers within the online social network.

In accordance with aspects of the present invention, the process further includes determining an activation percentage for each of the preferred at least one influencers based on the at least one post type. The process can also further include calculating a total number of social network posts created by the at least one influencers based on the activation percentage for each of the at least one influencers. The process can also further include predicting a number of digital reactions from their audience, such as impressions, clicks, conversions, engagements, etc. resulting from creation of the new content creation for each of the at least one influencers.

In accordance with example embodiments of the present invention, a system for maximizing a return on investment for marketing initiatives for content creation on social networks is provided. The system includes a knowledge module that aggregates data associated with available influencers and aggregates status information associated with one or more influencers and an evaluation module that evaluates whether one or more of the one or more influencers are available for activation for the content creation based on the aggregated data. The system also includes an optimization module that determines a level of optimization for activating the one or more of the one or more influencers are available for activation for the content creation. The optimization module returns at least one influencer of the one or more influencers to be activated for the content creation based on the determined level of optimization.

In accordance with aspects of the present invention, the status information comprises at least one of information related to an availability of an influencer, an influencer rating, types of content an influencer creates, historical information of time, engagements driven by posts from an influencer, and content types created by an influencer.

In accordance with aspects of the present invention, the evaluation module determines an influencer rating, a post type, and a time since a last post by an influencer for each of the one or more influencers. The knowledge module can also build a series of tables including data of the influencer rating, the post type, and the time since the last post by the influencer for each of the one or more influencers.

In accordance with aspects of the present invention, the optimization module determines a percentage of activation of the one or more influencers based on a desired post type for the content creation and based on historical post type usages of the one or more influencers. The optimization module can also calculate an estimated total number of posts that will be created by the one or more influencers based on the percentage of activation. The optimization module can also estimate a number of engagements that will result from posts created by the one or more influencers based on the estimated total number of posts.

In accordance with aspects of the present invention, the evaluation by the evaluation module comprises combination of an influencer rating, a post type of the content to be provided, engagements driven by posts of an influencer, and a time period since an influencer was last activated for content creation for each available influencer of the one or more influencers. Influencers of the one or more influencers can also be blocked from activation when the evaluation produces a result indicating a reduction in an influencer rating of an influencer based on a degradation assumption.

In accordance with aspects of the present invention, the one or more influencers comprise social media users that opt-in to participate in a marketing initiative or campaign.

In accordance with aspects of the present invention, the at least one influencer of the one or more influencers is rewarded based on creating and/or publishing content or social media user engagements resulting from the content creation.

In accordance with aspects of the present invention, the optimization module determines a time threshold for when an influencer should be allowed an opportunity to post the content creation since a last post for another content creation.

In accordance with example embodiments of the present invention, a method for maximizing a return on investment for marketing initiatives is provided. The method includes aggregating a plurality of influencers from a storage system of an online social network and a processor identifying at least one influencer from the plurality of influencers to be activated for new content creation, The identifying includes determining an influencer rating associated with each of the plurality of influencers, determining at least one social network post type for the new content creation to be posted, determining a time of a most recent social network content posting for each of the plurality of influencers, and determining a preferred at least one influencer from the plurality of influencers available to be activated based on the influencer rating, the at least one social network post type, and the time of a most recent content posting for each of the plurality of influencers. The method also includes outputting the preferred at least one influencer of the plurality of influences to be activated for the new content creation. The process minimizes a negative effect on a level of impact the preferred at least one influencer has over potential customers within the online social network.

In accordance with aspects of the present invention, the method further includes determining an activation percentage for each of the at least one influencers based on the at least one post type. The method can also further include calculating a total number of social network posts created by the at least one influencers based on the activation percentage for each of the at least one influencers. The method can also further include predicting a number of digital reactions from their audience resulting from creation of the new content creation for each of the at least one influencers.

### BRIEF DESCRIPTION OF THE FIGURES

These and other characteristics of the present invention will be more fully understood by reference to the following detailed description in conjunction with the attached drawings, in which:

FIG. 1 is an illustrative system for implementing a process of optimizing an amount of content presented to potential customers while minimizing negative impact on influencer influence;

FIG. 2 is an illustrative flowchart depicting the process in accordance with aspects of the present invention;

FIG. 3 is an illustrative flowchart depicting the process in accordance with aspects of the invention; and

FIG. 4 is a diagrammatic illustration of a high-level architecture for hardware capable of implementing the process in accordance with aspects of the present invention.

### DETAILED DESCRIPTION

An illustrative embodiment of the present invention relates to a process for determining an optimal amount and type of marketing content to produce by leveraging influencer entities (e.g., influencers) while minimizing negative impact on their influence. In other words, the present invention provides a process for determining the optimized utilization of marketing tools and influencers. More specifically, the process of the present invention takes into account the quantitative influence level metrics of an influencer and the response by the social network associated with the influencer to the content presented by the influencer to determine how frequently to “activate” the influencer in a manner that minimizes negative impact on their influence. Negative impact can result from over activating an influencer can nullify or hinder the effectiveness of that influencer in the future. Additionally, the process provided by the present invention can further optimize the presentation format (e.g., type of social media post(s)) of the content provided by the influencer based on the quantitative influencer level metrics.

The process provided by the present invention enables marketers to maximize usage of an influential entity on their own or as part of a marketing campaign or promotion utilizing multiple instances of individual influencers creating successive content to their respective online social networks. A common advertising tactic includes marketers providing influential individuals (ranging from celebrities, athletes, politicians, to everyday people that have influence over their social networks) with incentives (e.g., discounts, compensation, etc.) to provide advertising to potential customers. As would be appreciated by one skilled in the art, influential user, entities, etc. can include individual people, collections of people, entities (e.g., corporations, business, franchises, etc.), or any combination thereof. With the advent of the Internet and increased usage of social media, marketers have created a technology and entire technological field related to leveraging online social networks of influencers as a medium for providing advertising content to potential customers. It is desirable for marketers to optimize funds for the incentives provided to influencers to achieve the best exposure to potential customers. The present invention provides an improvement to the technology and technological field of influencer promotion via online social networks by providing an improved system and process to optimize marketing via activation of influencers to post content on social networks in a novel process that differs from how such influencer activity has been done previously. In particular, the present invention provides a system and process through a unique combination of steps for providing an optimized solution for marketing necessitated by the creation and widespread utilization of social media networks by activating influencers using a technology and a process that considered whether such activation would have a negative impact on the influence of the influencer and automatically determines whether or not to proceed with such activation based on the requirement to also minimize such negative impact.

The maximization of the influential entity provided by the present invention is optimized such that a marketer does not overuse any particular individual influencer, or group of influencers, and thus cause damage or degradation of the influencers' level of impact on users within their social network(s), which is therefore a different process than that which has been implemented prior to the present invention. In addition to the improved marketing for the marketer, potential customers within one or more social networks of the influencers benefit by a reduction in “spamming” of marketing materials provided by the marketers. Overall, the present invention provides a technology that enables marketers to more effectively utilize influencers and increase the return on investment (ROI) for marketing of a product and/or service.

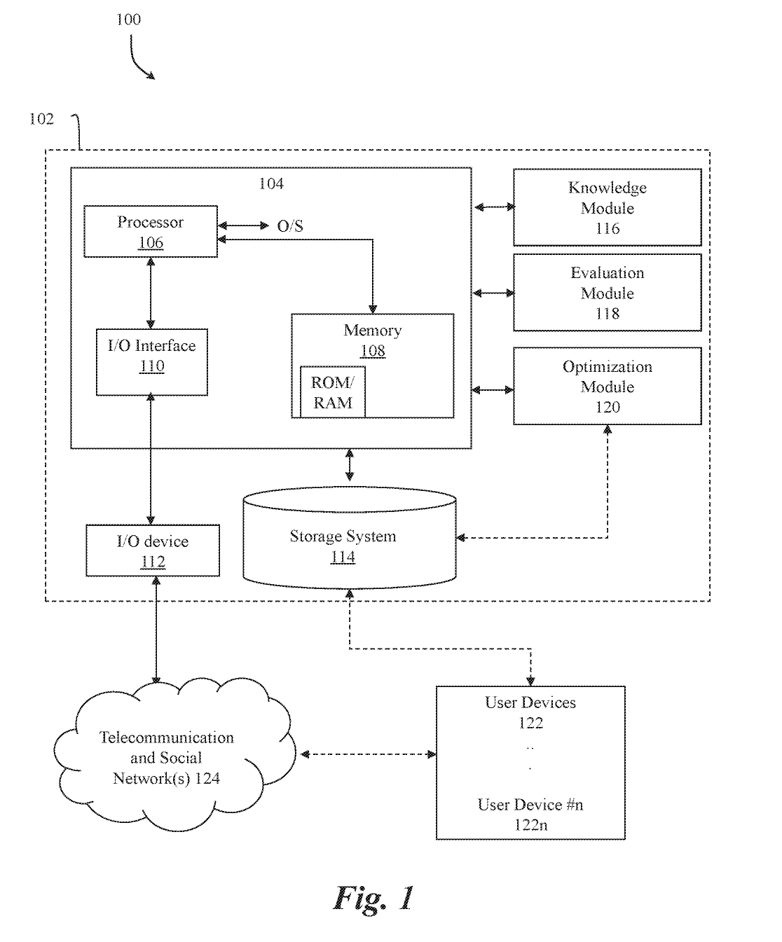

FIGS. 1 through 4, wherein like parts are designated by like reference numerals throughout, illustrate an example embodiment or embodiments of the marketing optimization system, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed in a manner still in keeping with the spirit and scope of the present invention.

FIG. 1 depicts an illustrative system 100 for implementing the steps in accordance with the aspects of the present invention. In particular, FIG. 1 depicts a system 100 including an influencer management system 102. In accordance with an example embodiment of the present invention, the influencer management system 102 is a combination of hardware and software configured to carry out aspects of the present invention. In particular, the influencer management system 102 can include a computing system with specialized software and databases designed for providing a process for optimizing activation of incentivized influencers while minimizing negative impacts on their influence. For example, the influencer management system 102 can be software installed on a computing device 104, a web based application provided by a computing device 104 which is accessible by computing devices (e.g., the user devices 122), a cloud based application accessible by computing devices, etc. The combination of hardware and software that make up the influencer management system 102 are specifically designed to provide a technical solution to a particular problem utilizing an unconventional combination of steps/operations to carry out aspects of the present invention in a novel process that did not exist in prior influencer advertising systems. In particular, the influencer management system 102 is designed to execute a unique combination of steps to provide a novel approach to the optimized management of influencers of content on social media. Specifically, the influencer management system 102 is configured to automatically provide a system and process to determine an optimized frequency in which to have an influential entity create content on a social network while maintaining the impact of the influential entity (i.e., by minimizing any negative impact on their influence).

In accordance with an example embodiment of the present invention, the influencer management system 102 can include a computing device 104 having a processor 106, a memory 108, an input output interface 110, input and output devices 112, and a storage system 114. Additionally, the computing device 104 can include an operating system (O/S) configured to carry out operations for the applications installed thereon. As would be appreciated by one skilled in the art, the computing device 104 can include a single computing device, a collection of computing devices in a network computing system, a cloud computing infrastructure, or a combination thereof. Similarly, the storage system 114 can include any combination of computing devices configured to store and organize a collection of data. For example, storage system 114 can be a local storage device on the computing device 104, a remote database facility, or a cloud computing storage environment. The storage system 114 can also include a database management system utilizing a given database model configured to interact with a user for analyzing the database data.

Continuing with FIG. 1, the influencer management system 102 includes a combination of core modules or tools to carry out the various functions of the present invention. In accordance with an example embodiment of the present invention, the influencer management system 102 can include a knowledge module 116, an evaluation module 118, and an optimization module 120. As would be appreciated by one skilled in the art, the knowledge module 116, the evaluation module 118, and the optimization module 120 can include any combination of hardware and software configured to carry out the various aspects of the present invention. In particular, each of the knowledge module 116, the evaluation module 118, and the optimization module 120 are configured to provide business marketers with optimization of their utilization of influencers in marketing content. For example, the modules 116, 118, 120 provide optimization of when to activate or not to activate influencers to post marketing content on their respective social networks. As would be appreciated by one skilled in the art, the modules 116, 118, 120 can be modified to apply to any type of marketing and advertising process and the example modules are not intended to limit the present invention to the utilization of influencers for marketing content.

In accordance with an example embodiment of the present invention, the system 100 can include a plurality of user devices 122 configured to communicate with the influencer management system 102 over a telecommunication and social network(s) 124. As would be appreciated by one skilled in the art, the plurality of user devices 122 can include any combination of computing devices, as described with respect to the influencer management system 102 computing device 104. For example, the computing device 104 and the plurality of user devices 122 can include any combination of servers, personal computers, laptops, tablets, smartphones, etc. Additionally, the user devices 122 can be utilized by any combination of user types (e.g., marketing manager users, influencer entities, potential customer users, etc.).

In accordance with an example embodiment of the present invention, the influencer management system 102 acts as a centralized host for the user devices 122, providing the functionality of the modules 116, 118, 120 and the present invention to the user over a secured network connection. In particular, the computing devices 104, 122 are configured to establish a connection and communicate over telecommunication and social network(s) 124 to carry out aspects of the present invention. As would be appreciated by one skilled in the art, the telecommunication and social network(s) 124 can include any combination of known networks. For example, the telecommunication and social network(s) 124 may be combination of a mobile network, WAN, LAN, or other type of network. The telecommunication and social network(s) 124 can be used to exchange data between the computing devices 104, 122, exchange data with the storage system 114, and/or to collect data from additional sources.

In accordance with an example embodiment of the present invention, the knowledge module 116 is configured to aggregate data for available influencers including the status information associated with the influencers. The available influencers and the data associated therewith can be influencers that are registered with the influencer management system 102 and the data can be stored in the storage system 114. The status information can include information related to an availability of an influencer, an influencer rating, types of content the influencer creates, historical information of time, engagements driven by posts from the influencer, and content types created by the influencer, etc. As would be appreciated by one skilled in the art, the knowledge module 116 can aggregate data through any combination of means known in the art. For example, the knowledge module 116 can maintain a database of all the influencers and update the database with information related to the influencers as it becomes available to the system. For example, the updating can be carried out periodically and/or when an event occurs (e.g., an influencer creates new content).

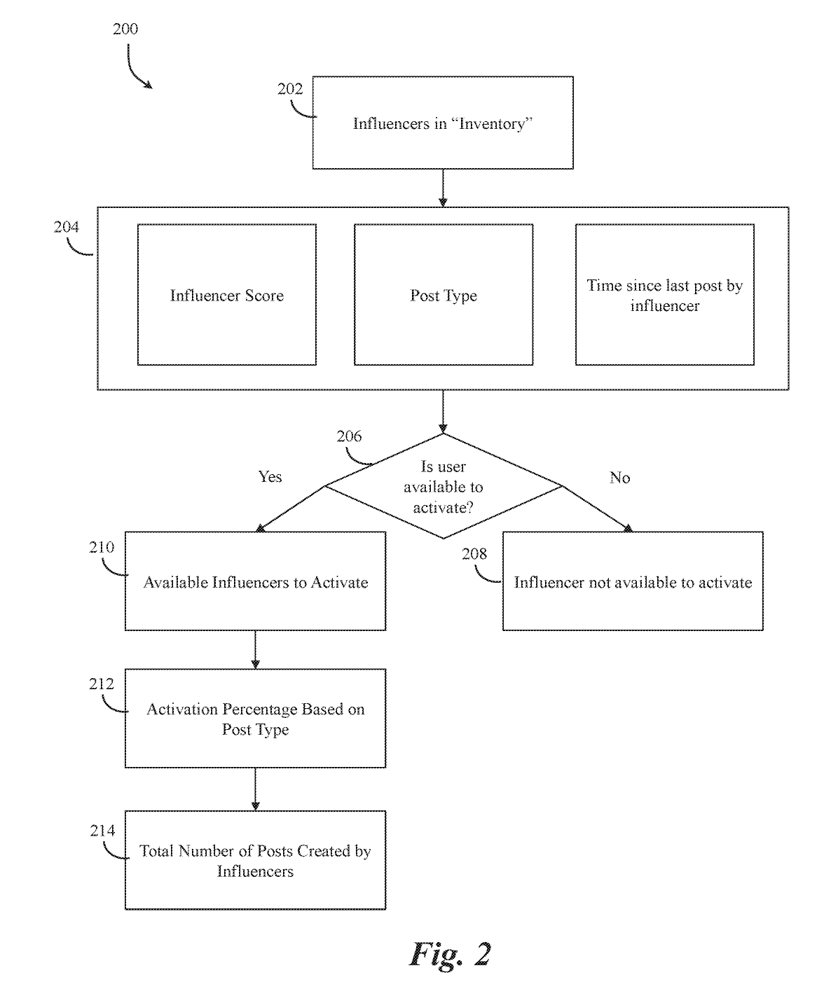

In accordance with an example embodiment of the present invention, the knowledge module 116 is configured to communicate with marketers (e.g., via user devices 122) to utilize influential entities in marketing, promotions, etc. Specifically, the knowledge module 116 can facilitate the functions necessary to setup an account for providing marketing, promotions, etc. , receive input from a marketer for the type of content to provide during the marketing, promotions, etc., receive criteria from the marketer for preferences on the marketing, promotions, etc. (e.g., type of post, frequency of posts, particular influencers, target audience, etc.), and any additional functionality necessary to run effective marketing, promotions, etc. Additionally, the knowledge module 116 can be configured to provide the appropriate incentives to influencers when the influencers post content in response to being activated by the influencer management system 102. In operation, prior to initialization of the steps in FIG. 2, the knowledge module 116 receives input from marketers for a desired marketing content to be provided by influencers (including the content to be provided and the incentives for providing the content).

In accordance with an example embodiment of the present invention, the evaluation module 118, is configured for evaluating whether the one or more influencers, in the inventory (as provided by the knowledge module 116), are available for “activation” for providing content. In particular, the evaluation module 118 combines an influencer rating, a post type of the content, engagements driven by the posts of the influencer, and a time period since the influencer's last post to determine which influencers are available for activation and which influencers should be blocked from activation. Influencers are blocked from activation when the combination produces an indication that activation would likely result a reduction in the influencer's effectiveness/score (e.g., based on a degradation assumption, as discussed in greater detail herein).

In accordance with an example embodiment of the present invention, the system constructs a historical data set that enables the system 100 to analyze and build a series of tables for quantitative influencer metrics. An illustrative example of such a table is provided in TABLE 1.

TABLE 1

| | | | | Time | | | User's | User's |
|---|---|---|---|---|---|---|---|---|
| | | | | Since | | Post | Influence | Influence |
| Influencer | | Post Social | Post | Last | Engagements | Influence | Score at | Percentage at |
| ID | Post Date | Network | Type | Post | on Post | Score | Time of Post | Time of Post |
| 1 | Feb. 1, 2017 | Facebook | Type 1 | n/a | 20 | 25 | 4,125 | 95 |
| 1 | Feb. 5, 2017 | Facebook | Type 1 | 4 | 10 | 11 | 3,912 | 80 |
| 1 | Feb. 28, 2017 | Instagram | Type 2 | 23 | 20 | 22 | 4,031 | 95 |
| 2 | Feb. 1, 2017 | Instagram | Type 1 | n/a | 20 | 17 | 578 | 95 |
| 2 | Feb. 10, 2017 | Facebook | Type 1 | 9 | 20 | 21 | 601 | 95 |
| 2 | Feb. 28, 2017 | Twitter | Type 4 | 18 | 20 | 19 | 596 | 95 |

The example of TABLE 1 includes columns for an influencer identification number, a post date for content by the influencer, a social network in which the content was posted, a type of post (e.g., text, multimedia, etc.), a period of time since the previous post by the influencer, a number of engagements on the post, a post influence score, the influencer of the influencer user at the time of posting, and the influencer user's percentage at the time of posting. Overall, the data included within the series of tables includes data for each post by each influencer that is compared against prior to activation of the influencer. As would be appreciated by one skilled in the art, the tables can omit and/or include additional columns without altering the scope of the present invention. For example, the tables can further include columns for a number of posts desired in a fixed period of time (e.g., two months) and a period between posts (e.g., three days). The tables provide a correlation between post performance, influence level, and degradation over time such that the performance of a post (engagements, etc.) will indicate whether the time is right to post. For example, an influencer with influencer rating of 90 posts weekly and gets 20 engagements and when the same influencer posts daily and gets 0-1 engagements per post, their influencer rating decreases as a result. The tracked number of engagements and the performance of those engagements is the leading indicator as to whether an influencer should be throttled back (e.g., to post weekly instead of daily).

With the tables built, the system 100 constructs a degradation formula based on the data in the tables. Additionally, in accordance with an example embodiment, the system 100 also includes a real time monitor that assesses posts and post history of an influencer as they continue to post and indicate whether the influencer should or should not be throttled. The key determining factor, as it relates to activating an influencer, is tracking a post-performance of that influencer. If a series of posts created by an influencer continue to perform better one after another, then the system 100 will not be applied as strictly as if the post-performance (e.g., engagements from friends) decreases/degrades. As a result, the post-performance is a micro representation of the influence level of an individual.

Additionally, the evaluation module 118 can be configured to determine an influencer rating, a post type (e.g., link, video, image, text, etc.), and a time since the last post by the influencer. The evaluation module 118 can determine the influencer rating utilizing any methodology know in the art. For example, the evaluation module 118 can determine the influencer rating (or impact score, used interchangeably herein) utilizing the methodology discussed in U.S. Pat. No. 9,026,594 (incorporated herein by reference). Similarly, both the post type and time since the last post can be determined by the evaluation module 118 by a simple look up from user inputs (e.g., marketer desired content post type) and historical data (e.g., historical post data for each influencer) stored by the system 100.

In accordance with an example embodiment of the present invention, the optimization module 120 is configured to determine a level of optimization for activating influencers. In particular, the optimization module 120 receives the influencers available for activation from the evaluation module and determines a percentage of activation for an influencer based on a post type (e.g., the post type desired by the marketer). For example, the optimization module 120 can determine that, upon activation, a particular influencer will post content related to a picture fifty percent of the time and only thirty-three percent of the time the influencer will post content related to a video. Based on the determined activation percentage for a post type, the optimization module 120 can estimate a total number of posts that will be created by all of the influencers available for activation. Utilizing the estimated number of posts, the optimization module 120 can further predict a number of engagements (e.g., clicks, conversions, impressions, etc.) that will result from the posts by the influencers. The estimated and predicted data can be provided by the optimization module 120 to the marketer to assist the marketer in determining whether a particular configuration will be successful prior to execution of the marketing, promotions, etc. In particular, the data will reflect to the marketer whether a particular post type for a particular set of available influencers will produce a satisfactory number of engagements if executed.

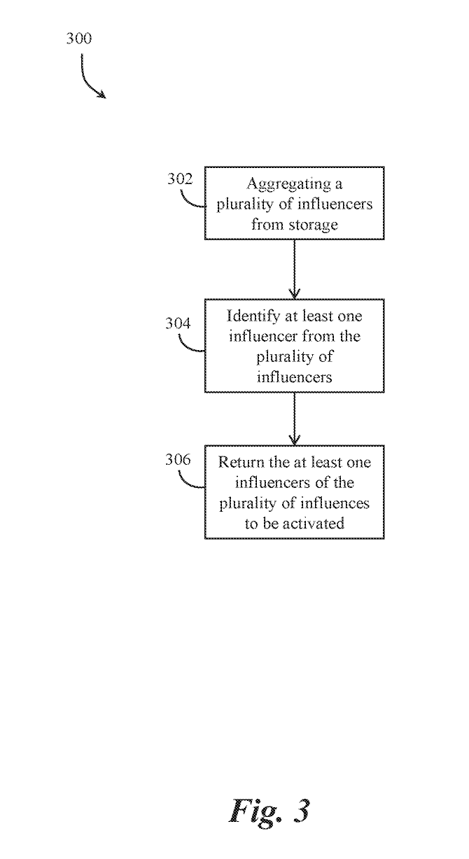

In operation, the system 100 provides a process and system for determining an optimal frequency of content creation by influencers on social networks. FIGS. 2 and 3 show exemplary flow charts depicting implementation of the system and process of the present invention. In particular, FIG. 2 depicts an exemplary process 200 in which the modules 116, 118, 120 work in combination to carry out the aspects of the present invention. Initially, the process 200 receives, from the knowledge module 116, requests to provide content via influencers for marketing, promotions, etc. for marketers. At step 202, the process 200 begins by accessing the knowledge module 116 to aggregate all of the influencers in the “inventory” of the system 100. The influencers in the inventory of the system 100 (e.g., in the storage system 114) includes all influencers known, registered, etc. by the system 100. In particular, influencers included in the inventory are influencers that have chosen to “opt-in” to participate in the marketing initiative or campaign utilized by the system 100. As would be appreciated by one skilled in the art, the knowledge module 116 can be configured to sign up influencers to participate within the system 100 and provide content for marketers. Additionally, the inventory of influencers can be further filtered based on preferences provided by a marketer, such that step 202 optionally includes identifying influencers according to a preferred relevancy as defined by a marketer. For example, a marketer may specify specific influencers or a class of influencers to target a particular group of potential customers. By identifying the relevant influencers of the available influencers, the system 100 does not have to calculate a rating for all available influencers.

At step 204, the process 200 accesses the evaluation module 118 to determine which of the influencers in the inventory are enabled for activation. The activation includes the influencer management system 102 requesting available influencers to post content in accordance requests received from a marketer for marketing, promotions, etc. The determination includes executing a process, based on tabular data (e.g., such as TABLE 1) stored in the storage system 114, that combines an influencer's rating, around a certain post type, with a time based degradation assumption that “blocks” certain influencers from being able to be “activated” so as not to reduce the influencer's effectiveness/score, as discussed in greater detail herein. The influencers that are determined to be available to be activated (e.g., post content) are maintained in a list of available influencers. For example, the influencers that have not exceeded a number of posts over a threshold period of time to produce a satisfactory effectiveness score can be determined to be available for activation. In contrast, the influencers that are flagged as unavailable for activation are removed from the list of influencers available for activation (e.g., to post content). The resulting list of available influencers provided during the determination is processed and transmitted to the optimization module 120 for additional processing.

In accordance with an example embodiment of the present invention, based on historical data, the influencer management system 102 determines a time threshold for when an influencer should not be allowed the opportunity to post again (e.g., not be activated). The determination not to activate an influencer can be based on a combination of factors. For example, the determination can be based on a predetermined number of successive posts within a given time frame selected to avoid having a negative impact on the performance of posts provided by the influencer. Similarly the determination can be based on a derived “effectiveness” of an influencer's post based on a combination of factors. For example, the effectiveness can be determined utilizing factors including a time between posts, type(s) of activities (e.g., posts), and the influencers score (initial patented process). The effectiveness is determined based on a number of likes, comments, shares, clicks, etc. that each type(s) of activities (e.g., post) receives. It is through the influencer level, the number of these metrics, and the frequency of post that the present invention determines a level of effectiveness for each successive type(s) of activities. The effectiveness of each influencer will vary based on the derived effectiveness value. The premise behind the varied effectiveness values is that a user that is less influential and posts too often will continue to diminish an overall effectiveness or influence whereas a highly influential entity may be able to post a content more frequently without diminishing an overall effectiveness or influence of that user. Accordingly, the historical data utilized by the influencer management system 102 provides the information necessary to determine the appropriate list of “available” influencers to maximize activity and maintain the total influence level of each influencer.

In accordance with an example embodiment of the present invention, the effectiveness of each influencer is based on the types of posts that have the potential of receiving reaction from potential customers in the influencer's social network or “public activities” will be considered for the throttling. Likewise, semipublic activities that made available only to a select group of followers/potential customers can also be considered for the throttling. Any posts that are provided internal or non-public, such as a survey or video watch by the influential entity will not be considered as part of the throttling mechanism. The types of post that are internal or non-public are not considered to have an impact on the time between posts causing degradation in an influencer's effectiveness. In other words, private actions performed by the influencer on a platform (e.g., third party software with social network integration) separate from their social network such as filling out a private survey, watching a video, etc. are not factored into the throttling but the number times an influencer posts content publically to solicit a purchase or an advertisement view is factored into the throttling. The third party software provides a platform in which the influencer participates in activities. For example, a user (e.g., an influencer) logs into the platform and provide opt-in access to their social profile—where they are scored by the system 100. As the user starts to complete activities (some internal to the platform and some external on social networks) they are further scored on their performance on the external posts. It is these external posts on the social networks that the system 100 monitors for performance and utilized to determine whether they should be throttled. The opt-in access to the user's social profile and social activities through the platform enables the system 100 to measure monitor the user performance and then determine whether they should be activated. The key to the throttling is tracking a frequency of public posts utilizing a threshold value. The threshold value can be a predetermined value or a value derived by the influencer management system 102. For example, a threshold value for the time between posts can be calculated based on the historical data for each individual influencer and each post type. Accordingly, the combination of externally facing or public activities, the historical performance of those activities, and a frequency of public posts, and an influence level of the influencer that are utilized to calculate what group of influencers should be “available” to post marketing content for the influencer management system 102.

In accordance with an example embodiment of the present invention, the influencer management system 102 utilizes past performance data in the historical data to determine the effectiveness level of influencers. In particular, the influencer management system 102 (e.g., the knowledge module 116) records a number of engagements resulting from each of the content posts submitted by an influencer in response in their social network in response to being activated. The number of engagements (e.g., likes, comments, shares, impressions, etc.) is utilized to determine how the posted content performed. As would be appreciated by one skilled in the art, the level of performance can be determined utilizing a number of metrics. For example, the number of engagements for a particular post for a particular influencer can be compared against an average number of engagements resulting from each influencer that posted the particular post to determine the performance of the particular influencer and correlated to their influence score. Similarly, a number of engagements for a post of a particular influencer can be compared against resulting engagements from previous posts of the same post type by that particular influencer to determine how the current post is performing. Utilizing the performance metrics, the influencer management system 102 can measure any increase and decrease of engagements for all instances of successive posts for each individual influencer. Additionally, the influencer management system 102 can compare the instances where successive post performance decreased and determine a maximum time between activity completion that had the minimum decrease or no decrease at all for that user and activity type. As a result, the influencer management system 102 takes into account a level of degradation of when the “voice” of an influencer would be diminished and as such should cease from being used so as not to burn out the usefulness of the influencer.

Continuing with FIG. 2, at steps 206 to 214, the process 200 accesses the optimization module 120 to provide predictive statistics for the activation of the available influencers. At step 206, the optimization module 120 gathers a list of influencers available for activation from the results provided by the evaluation module 118 at step 204. In particular, at step 206, the system inspects each individual influencer to determine whether or not that influencer is available to activate. If the process 200 determines that the influencer is not available to activate, the process adds the influencer to the influencers not available to activate at step 208. Otherwise, if the process 200 determines that the influencer is available to activate, the process adds the influencer to the influencers available to activate at step 210.

Additionally, at step 210, the knowledge module 116 can notify the identified influencers available for activation that they have been selected and are provided with the opportunity to activate (e.g., post provided content to their social network). When presented with the opportunity to activate by the influencer management system 102, each influencer can choose whether or not to post the provided content in their social network and receive the associated incentives upon posting the content.

At step 212, the optimization module 120 determines an activation percentage for each of the influencers determined to be available for activation. The activation percentage can be determined by the optimization module 120 looking up historical data for each of the influencers, including past activations of those influencers. In particular, the optimization module 120 utilizes the historical data to determine what percentage of the time that each influencer posts content for each type of post in past activations. For example, historical information for a particular influencer may indicate that that influencer posts content in the form of pictures fifty percent of the time and content in the form of videos thirty-three percent of the time in response to activation requests presented by the system 100.

At step 214, the optimization module 120 further calculates an estimated number of posts that will be created by the activated influencers, based on the activation percentage from step 212. In particular, the calculated number of posts that the influencers will be created based on the estimated activation percentage with the different types of posts. Additionally, the optimization module 120 can also predict how many digital response or engagements will result from the estimated number of posts. For example, the predicted digital response or engagements can include any user action resulting from the posted content, including but not limited to a number of clicks, conversions, likes, comments, shares, etc. As would be appreciated by one skilled in the art, each of the estimations/predictions provided by the optimization module 120 can be based on a combination of historical post data and other historical data available to the system 100. Based on the conclusion of steps 202-214, the system 100 can determine whether or not each of the available influencers can and therefore should be activated.

In accordance with an example embodiment of the present invention, to carry out steps 204 to 214, the system 100 measures every activity made by the influencers as they engage the influencer management system 102. In particular, the influencer management system 102 records each activity type (e.g., posting, non-posting in response to an activation, etc.) that is completed or not completed by each influencer and stores it in the historical data. Additionally, each instance in which the system submits an activation for one or more influencers, the time of the activation is time-stamped and recorded in the storage system 114 (e.g., by the knowledge module 116). With the combination of the information related to influencer activity and the information related to past activations, the influencer management system 102 can calculate the time between activation and the activity completion (e.g., content posting) by an influencer (e.g., the time between activation and post activity carried out by the influencer) and potential future activity completion. As would be appreciated by one skilled in the art, the calculations can include any combination of average activities and/or some standard deviations thereof.

In accordance with an example embodiment of the present invention, the historic posting data includes any combination of a unique influencer identifier (e.g., identifiers associated with the influencer entities), unique activity identifier (e.g., identifiers associated with posted content), activity time stamp, activity type or post type, activity internal/external (private/public posts), a number of engagements per post, and a duration of time since a most recent activity completion (e.g., post). The historic posting data can be obtained and correlated by the system 100 based on unique influencers completing external activities and measuring an impact on a performance of a post (e.g., a number of engagements created by that post) with variable time between successive posts. The historic posting data can then be utilized to limit the list of influencers available in the present/real time to post branded content to the public. For example, an influencer may be determined to be unavailable due to too many posts created in a short period of time.

FIG. 3 depicts a process 300 for executing a method of use in accordance with the present invention. In particular, the process 300 includes steps for identifying influencers available to activate from a pool of influencers. At step 302, the process 300 aggregates a plurality of influencers from storage. At step 304, the process 300 identifies at least one influencer from the plurality of influencers to be activated for new content creation. The identifying including determining an influencer rating associated with each of the plurality of influencers, determining at least one post type for the new content creation to be posted, determining a time of a most recent content posting for each of the plurality of influencers, and determining the at least one influencer from the plurality of influencers available to be activated based on the influencer rating, the at least one post type, and the time of a most recent content posting for each of the plurality of influencers.

At step 304, the system 100 executes the process outlined in step 204 of FIG. 2. In particular, the additional steps in step 304 can include determining an activation percentage for each of the at least one influencers based on the at least one post type, calculating a total number of posts created by the at least one influencers based on the activation percentage for each of the at least one influencers, and predicting a number of impressions, clicks, conversions, and engagements resulting from creation of the new content for each of the at least one influencers. At step 306 the system 100 returns the at least one influencers of the plurality of influences to be activated for the new content creation. The returning of the at least one influencers includes activating and notifying the at least one influencers of the activation to provide content on their social networks.

An example implementation of the process 300 for the present invention is provided below. The example implementation is not intended to limit the present invention but is for explanation purposes only. In particular, the example implementation is an example of tracking activity of an influencer and utilizing the tracked activity to determine influencers available for activation. Initially, historical data for social network posts are created by an Influencer A and an Influencer B, who at the time of their initial posts have the same influencer rating. The Influencer A provides a social media post W on May 5, 2016 which receives twenty-five engagements from potential customers. Thereafter, the Influencer A completes a social media post X on May 25, 2016 which receives fifty engagements from potential customers. The Influencer B completes a social media post Y on May 28, 2016 which receives thirty-five engagements from potential customers. Thereafter, Influencer B completes a social media post Z on May 30, 2016 which receives twenty-five engagements from potential customers which results in a decrease in Influencer B's influencer rating. A new social media post content for a marketer is made available by the system 100 on Jul. 1, 2016 where Influencer A and Influencer B fit in the target of the audience for that content. The system 100 determines, based on proximity of time between social media posts Y and Z for Influencer B and the corresponding decrease in engagements that Influencer B will not be given the opportunity to be activated for providing content for the new social media post. As a result, only Influencer A will be activated to provide the content.

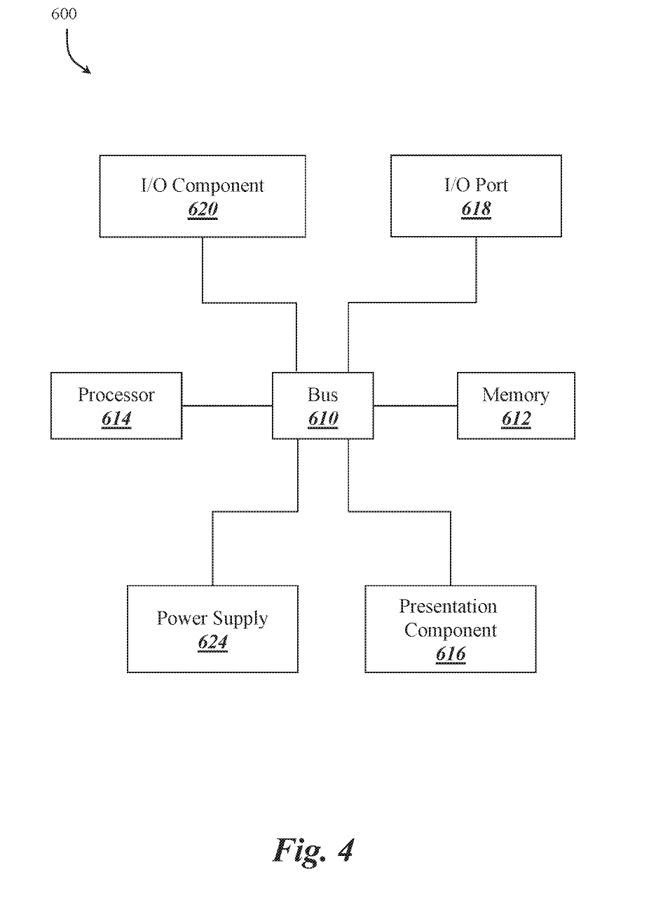

Any suitable computing device can be used to implement the computing devices 102, 104, 122 and methods/functionality, including cloud functionality, described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 600 is depicted in FIG. 4. The computing device 600 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

what is claimed is:

1. A computer implemented process, comprising:
aggregating a plurality of influencers from a storage system of an online social network;
a processor identifying at least one influencer from the plurality of influencers to be activated for new content creation, the identifying comprising:
determining an influencer rating associated with each of the plurality of influencers;
determining at least one social network post type for the new content creation to be posted;
determining a time of a most recent social network content posting for each of the plurality of influencers; and
determining a preferred at least one influencer from the plurality of influencers available to be activated based on the influencer rating, the at least one social network post type, and the time of a most recent content posting for each of the plurality of influencers; and
outputting the preferred at least one influencer of the plurality of influences to be activated for the new content creation;
wherein the process minimizes a negative effect on a level of impact the preferred at least one influencer has over potential customers within the online social network.

2. The process of claim 1, further comprising determining an activation percentage for each of the preferred at least one influencers based on the at least one post type.

3. The process of claim 2, further comprising calculating a total number of social network posts created by the at least one influencers based on the activation percentage for each of the at least one influencers.

4. The process of claim 3, further comprising predicting a number of impressions, clicks, conversions, and engagements resulting from creation of the new content creation for each of the at least one influencers.

5. A system for maximizing a return on investment for marketing initiatives for content creation on social networks, the system comprising:
a knowledge module that aggregates data associated with available influencers and aggregates status information associated with one or more influencers;
an evaluation module that evaluates whether one or more of the one or more influencers are available for activation for the content creation based on the aggregated data; and
an optimization module that determines a level of optimization for activating the one or more of the one or more influencers are available for activation for the content creation;
wherein the optimization module returns at least one influencer of the one or more influencers to be activated for the content creation based on the determined level of optimization.

6. The system of claim 5, wherein the status information comprises at least one of information related to an availability of an influencer, an influencer rating, types of content an influencer creates, historical information of time, engagements driven by posts from an influencer, and content types created by an influencer.

7. The system of claim 5, wherein the evaluation module determines an influencer rating, a post type, and a time since a last post by an influencer for each of the one or more influencers.

8. The system of claim 7, wherein the knowledge module builds a series of tables including data of the influencer rating, the post type, and the time since the last post by the influencer for each of the one or more influencers.

9. The system of claim 5, wherein the optimization module determines a percentage of activation of the one or more influencers based on a desired post type for the content creation and based on historical post type usages of the one or more influencers.

10. The system of claim 9, wherein the optimization module calculates an estimated total number of posts that will be created by the one or more influencers based on the percentage of activation.

11. The system of claim 10, wherein the optimization module estimates a number of engagements that will result from posts created by the one or more influencers based on the estimated total number of posts.

12. The system of claim 5, wherein the evaluation by the evaluation module comprises combination of an influencer rating, a post type of the content to be provided, engagements driven by posts of an influencer, and a time period since an influencer was last activated for content creation for each available influencer of the one or more influencers.

13. The system of claim 12, wherein influencers of the one or more influencers are blocked from activation when the evaluation produces a result indicating a reduction in an influencer rating of an influencer based on a degradation assumption.

14. The system of claim 5, wherein the one or more influencers comprise social media users that opt-in to participate in a marketing initiative or campaign.

15. The system of claim 5, wherein the at least one influencer of the one or more influencers is rewarded based on creating and/or publishing content or social media user engagements resulting from the content creation.

16. The system of claim 5, wherein the optimization module determines a time threshold for when an influencer should be allowed an opportunity to post the content creation since a last post for another content creation.

17. A method for maximizing a return on investment for marketing initiatives, the method comprising:
aggregating a plurality of influencers from a storage system of an online social network;
a processor identifying at least one influencer from the plurality of influencers to be activated for new content creation, the identifying comprising:
determining an influencer rating associated with each of the plurality of influencers;
determining at least one social network post type for the new content creation to be posted;
determining a time of a most recent social network content posting for each of the plurality of influencers; and
determining a preferred at least one influencer from the plurality of influencers available to be activated based on the influencer rating, the at least one social network post type, and the time of a most recent content posting for each of the plurality of influencers; and
outputting the preferred at least one influencer of the plurality of influences to be activated for the new content creation;
wherein the process minimizes a negative effect on a level of impact the preferred at least one influencer has over potential customers within the online social network.

18. The method of claim 17, further comprising determining an activation percentage for each of the at least one influencers based on the at least one post type.

19. The method of claim 18, further comprising calculating a total number of social network posts created by the at least one influencers based on the activation percentage for each of the at least one influencers.

20. The method of claim 19, further comprising predicting a number of impressions, clicks, conversions, and engagements resulting from creation of the new content creation for each of the at least one influencers.
